(19) United States
(12) Patent Application Publication
(10) Pub. No.: US 2007/0205106 A1
(43) Pub. Date: Sep. 6, 2007

(54) Electrophoresis Apparatus

(75) Inventors: Gyula Vigh, Mapudia, TX (US); Peniel Lim, Houston, TX (US)

Correspondence Address: MORGAN LEWIS & BOCKIUS LLP, 1111 PENNSYLVANIA AVENUE NW, WASHINGTON, DC, 20004, US

(73) Assignee: The Texas A&M University System

(21) Appl. No.: 10/576,939

(22) PCT Filed: Oct. 25, 2004
(86) PCT No.: PCT/US04/35466

§ 371 Date: Jan. 8, 2007

Related U.S. Application Data
(60) Provisional application No. 60/513,533, filed on Oct. 24, 2003.

(51) Int. Cl. B01D 61/42

(52) U.S. Cl. 204/518; 204/627

(57) ABSTRACT

An electrophoresis apparatus for measuring, characterizing and/or altering a composition of a sample. The apparatus comprises an anode compartment having an anode and a cathode compartment having a cathode. The anode and cathode are spaced at a distance from one another to define an electric field having a direction along a longitudinal axis, and between the anode and cathode compartments can be at least one separation compartment. Each compartment includes means for adding or removing a solution, a first dimension orthogonal to the direction of the electric field, a second dimension orthogonal to the electric field and the first dimension, and a third dimension parallel to the electric field and orthogonal to the first and second dimensions. A ratio of the first and second dimensions define an aspect ratio, at least one aspect ratio being less than one. An ion-permeable barrier is positioned between each compartment to prevent convective mixing therebetween. At least one of the compartments can be made of an electrically insulating material having a thermal conductivity greater than about 1 W/mK and a specific heat greater than about 100 J/kgK.

### FIELD OF THE INVENTION

The present invention relates to an electrophoresis apparatus and methods of its use for fractionation of a complex sample.

### BACKGROUND OF THE INVENTION

All publications and patent applications herein are incorporated by reference to the same extent as if each individual publication or patent application was specifically and individually indicated to be incorporated by reference.

The following description includes information that may be useful in understanding the present invention. It is not an admission that any of the information provided herein is prior art or relevant to the presently claimed inventions, or that any publication specifically or implicitly referenced is prior art.

Electrophoresis has been widely applied in separating proteins, nucleic acids, and other charged molecule species for analytical or preparative purposes, and also in the analytical or preparative fractionation of heretogeneous populations of dispersed cells or other types of macroscopic particles. In the analysis of complex ampholytic samples, such as in proteomics, it would often be desirable to reduce the complexity of a sample by pre-fractionation. Two dimensional electrophoresis (2DE) is believed to be currently the most commonly used separation method in proteomics. In the first dimension of 2DE, conventional gel isoelectric focusing (CGIEF) or better yet, immobilized pH gradient IEF (IPGIEF) are used to separate proteins according to their pI values.

Both CGIEF and IPGIEF have numerous practical problems including a limited sample loading capacity, a limited dynamic range, precipitation of proteins during IEF separation (streaking) and an inability to tolerate a large amount of salts in the samples. P. G. Righetti et al., (Electrophoresis 21, 2000, 3639-3648); P. G. Righetti et al., (Anal. Chem. 73, 2001, 320A-326A) and D. W. Speicher et al., (Anal. Biochem., 284, 2000, 266-278); X. Zou & D. W. Speicher, (Proteomics, 2, 2002, 58-68) have shown that pre-fractionation of a complex protein sample in a multi-compartmental electrolyzer significantly improves the performance of 2DE. It is believed that the common limitation of both the ISOELECTRIQ2™ unit, marketed by Proteome Systems™ and the ZOOM™ unit, marketed by INVITROGEN™ is two-fold. First, the distance between the center of the separation compartment and its walls is relatively large (greater than about 5 mm), and second, the electrophoretic migration distance in each compartment is long, about 25 mm and 13 mm, respectively. The first, coupled with the fact that the separation compartments are made of thermally insulating polymers, leads to poor Joule heat dissipation and severely limits the electric power that can be applied to the system (max. 5 W and 3.5 W, respectively). The second, coupled with the low electrophoretic mobilities brought about by the low field strength, a consequence of the limited heat dissipation capability of the systems and the long electrophoretic migration distance, leads to slow separation velocities. Consequently, the fractionation times in these systems are long, 6 to 16 hours and 4 hours, respectively. Both systems use compartments with relatively large volumes (about 5 ml and 0.7 ml for each compartment, respectively), and the volume of the compartments cannot be easily reduced.

Gradipore Limited (Life Therapeutics) developed a small scale electrophoresis unit for size-based and charge-sign-based fractionation of complex samples (WO 01/8878, incorporated herein by reference). It is believed that, in practice, active cooling of at least the electrolytes was required to prevent over-heating of labile proteins during electrophoresis. Gradipore subsequently developed a scaled-down version of the GRADIFLOW™ electrophoresis unit, for size-based and charge-sign-based pre-fractionation of complex samples. In this MICROFLOW™ system, about 3 cm×4 cm polymer frames, separated by polyacrylamide membranes, are stacked next to each other to form the separation compartments and contain stagnant sample solutions. The compartment stack is terminated at both ends by a large volume anode compartment and cathode compartment. It is believed that in practice, the anolyte and catholyte are cooled and circulated through these compartments to provide convective heat removal.

Slow separation speed of the currently known electrophoresis systems, specifically, isoelectric fractionation systems, useful as they are, are believed to be due to the failure of existing systems to sufficiently address three interrelated design limitations. The first speed limitation comes from the fact that as the ampholytic components of a sample approach their isoelectric state, their electrophoretic mobilities approach zero. Consequently, when the components are close to their isoelectric state, they need an increasingly longer time to move across a certain distance. The second speed constraint comes from mechanical design problems that limit how short the electrophoretic migration path and how small the volume of the individual compartments holding the sample solutions can be before mechanical assembly and leak-tight sealing of the compartments become very difficult. The third performance limitation comes from the amount of Joule heat that is produced during electrophoresis. Since Joule heat dissipation occurs through the walls of the separation compartment, and since heat must first be transported from the separation medium to the wall, both of which are inefficient processes, the amount of Joule heat produced during fractionation must be limited and external, active cooling means must be applied. This means that the electric power input into the system to effect a separation must be limited. This results in a low electric field strength which, in turn, results in slow electrophoretic migration velocities and concomitant long separation times presently observed with current apparatus.

Accordingly, there exists a need for an electrophoresis apparatus or device suitable for processing small volume samples while effectively dissipating the heat generated during electrophoresis and reducing separation times. More specifically, the second and third speed limitations discussed above can be eliminated or negated to a great extent by selecting a structural material for the separation compartments of an electrophoresis apparatus that is a good electrical insulator yet has a relatively high thermal conductivity and specific heat. From these materials, one could make separation compartments that act as high capacity heat sinks by creating small separation compartments with appropriately selected characteristic dimensions in relatively large pieces. These heat sinks would greatly mitigate the need for active external cooling and/or for the reduction of the electrophoretic power used.

### SUMMARY OF THE INVENTION

The present invention relates to an electrophoresis apparatus and methods of its use for fractionation of a complex sample. The apparatus more specifically relates to Membrane-Separated Wells for Isoelectric Focusing and Trapping (MSWIFT). Primary application areas of MSWIFT and its modes of operation are in the analytical-scale fractionation of complex samples, such as pre-fractionation of protein samples for proteomic analysis, preparation of fractions for mass spectral (MS) analysis, bioactivity testing, enzymatic analysis, etc., rapid selection of isoelectric membranes for preparative-scale isoelectric trapping (IET) separations, and characterization of isoelectric membranes.

The present invention provides for an electrophoresis apparatus for characterizing, measuring and/or altering a composition of a sample. The apparatus comprises an anode and a cathode, the cathode spaced from the anode so as to define a distance along a longitudinal axis, the anode and cathode further defining an electric field having a direction substantially along the longitudinal axis. The apparatus includes an anode compartment, the anode disposed therein and a cathode compartment, the cathode disposed therein. Each of the anode compartment and the cathode compartment can be configured to hold at least one electrolyte, and at least one of the anode compartment and the cathode compartment can be configured to hold at least a portion of the sample. Each of the anode compartment and the cathode compartment includes means for addition or removal of a solution, a first compartment dimension, a second compartment dimension, and a third compartment dimension. The first compartment dimension can be substantially orthogonal to the direction of the electric field, and the second compartment dimension can be substantially orthogonal to the direction of the electric field and the first compartment dimension. A ratio of the first compartment dimension and the second compartment dimension defines an aspect ratio of the compartment, and the third compartment dimension can be substantially parallel to the direction of the electric field and substantially orthogonal to the first and second compartment dimensions. The apparatus further comprises an ion-permeable barrier positioned between the anode compartment and the cathode compartment. The ion-permeable barrier can be configured to prevent convective mixing between compartments. At least a portion of at least one of the anode and cathode compartments can be made of an electrically insulating material having a thermal conductivity greater than about 1 W/mK and a specific heat greater than about 100 J/kgK and the aspect ratio of at least one of the anode compartment and the cathode compartment can be less than one.

The electrophoresis apparatus preferably further comprises sealing means disposed between the anode compartment and the cathode compartment. The sealing means is preferably adapted to contain the ion-permeable barrier and provide access of ions to the ion-permeable barrier. Wherein the sealing means is made of a water insoluble polymer, the polymer can be natural or synthetic. Preferably, the water insoluble polymer of is selected from the group consisting of polyethylene, polypropylene, polyisobutylene, polyalkylenes, polyfluorocarbons, poly(dimethylsiloxane), poly(dialkylsiloxane), poly(alkylarylsiloxane), poly(diarylsiloxane), poly(ether ketones) or a combination thereof.

The electrophoresis apparatus further preferably comprises housing means for containing the anode and cathode compartments. Preferably, at least a portion of the housing means is made of a material having a thermal conductivity greater than about 1 W/mK and a specific heat greater than about 100 J/kgK. Moreover preferably, material of the at least portion of the housing means can be selected from the group consisting of alumina, aluminum nitride, zirconia, zirconium nitride, boron nitride, silicon nitride, silicon carbide, ceramics, fused silica, quartz, glass or any combination thereof.

The electrically insulating material of the at least one part of the anode or cathode compartment can be preferably selected from the group consisting of alumina, aluminum nitride, zirconia, zirconium nitride, boron nitride, silicon nitride, silicon carbide, ceramics, fused silica, quartz, glass or any combination thereof.

Preferably, the ion-permeable barrier is essentially free of weekly acidic functional groups or weakly basic functional groups or anionic functional groups or cationic functional groups. Alternatively, the ion-permeable barrier can be an isoelectric barrier.

In an alternative embodiment of an electrophoresis apparatus according to the present invention for measuring, characterizing, or altering a composition of a sample, the apparatus comprises an anode and a cathode, the cathode spaced from the anode so as to define a distance along a longitudinal axis, the anode and cathode further defining an electric field having a direction substantially along the longitudinal axis. The apparatus includes an anode compartment having an anode disposed therein and a cathode compartment having a cathode disposed therein. At least one separation compartment is preferably positioned between the anode and cathode compartments. Each of the anode compartment, cathode compartment and at least one separation compartment can be configured to hold at least one electrolyte. At least one of the anode compartment, cathode compartment and at least one separation compartment can be configured to hold at least a portion of the sample, and each of the anode compartment, cathode compartment and at least one separation compartment includes means for an addition or removal of a solution, a first compartment dimension, a second compartment dimension, and a third compartment dimension. The first compartment dimension can be substantially orthogonal to the direction of the electric field, the second compartment dimension can be substantially orthogonal to the direction of the electric field and the first compartment dimension. A ratio of the first compartment dimension and the second compartment dimension defines an aspect ratio of the compartment, and the third compartment dimension is preferably substantially parallel to the direction of the electric field and substantially orthogonal to the first and second compartment dimensions. The apparatus further includes an ion-permeable barrier positioned between each of the anode compartment, the at least one separation compartment and the cathode compartment. The ion-permeable barrier can be configured to prevent convective mixing therebetween. At least a portion of at least one of the anode compartment, the cathode compartment and the at least one separation compartment is made of an electrically insulating material having a thermal conductivity greater than about 1 W/mK and a specific heat greater than about 100 J/kgK and the aspect ratio of at least one of the anode compartment, the cathode compartment and the at least one separation compartment is less than one.

The present invention further provides for a method of altering a composition of a sample by electrophoresis which includes providing an electrophoretic apparatus according to the present invention. The method further includes selecting an ion-permeable barrier for use between the anode and cathode compartments, providing an electrolyte to the anode compartment, providing an electrolyte to the cathode compartment, providing at least a portion of a sample to at least one of the compartments, creating an electrophoretic direct current between the anode and the cathode by applying an electric potential between the anode and the cathode, and causing a transfer of at least one part of at least one component of the sample across the ion-permeable barrier. Alternatively, a method according to the present invention can include providing at least a portion of a sample to at least one of the compartments of an apparatus according to the present invention, providing at least one electrolyte to any of the compartments free of a sample component, creating an electrophoretic direct current between the anode and the cathode by applying an electric potential between the anode and the cathode, and causing a transfer of at least one part of at least one component across an ion-permeable barrier.

### BRIEF DESCRIPTION OF THE DRAWINGS

The accompanying drawings, which are incorporated herein and constitute part of this specification, illustrate an embodiment of the invention, and, together with the general description given above and the detailed description given below, serve to explain features of the invention.

FIGS. 1A and 1B are exploded top and plan cross-sectional views of a first preferred embodiment of an electrophoresis apparatus according to the present invention;

FIGS. 2A and 2B are exploded top and plan cross-sectional views of another preferred embodiment of an electrophoresis apparatus according to the present invention;

FIGS. 3A and 3B are exploded top and plan cross-sectional views of another preferred embodiment of an electrophoresis apparatus according to the present invention;

FIG. 4A is a top view of a preferred embodiment of an electrode compartment or separation compartment for use in an electrophoresis apparatus according to the present invention;

FIG. 4B is a cross-sectional view of the compartment of FIG. 4A along line IVB-IVB;

FIG. 4C is a plan view of the compartment of FIG. 4A along line IVC-IVC;

FIG. 5A is a top view of a preferred embodiment of an electrode compartment or separation compartment for use in the apparatus of FIG. 1;

FIG. 5B is a cross-sectional view of the compartment of FIG. 5A along line VB-VB;

FIG. 5C is a plan view of the compartment of FIG. 5A;

FIG. 6A is a cross-sectional view of a preferred embodiment of sealing means for use in another preferred embodiment of an electrophoresis apparatus according to the present invention;

FIG. 6B is a plan view of the sealing means of FIG. 6A;

FIG. 7A is a preferred embodiment of a sealing means for use in the apparatus of FIG. 1;

FIG. 7B is a cross-sectional view of the sealing means of FIG. 7A along line VIIB-VIIB;

FIG. 7C is a plan view of the sealing means of FIG. 7A;

FIG. 8 is a graphic result of an imaging isoelectric focusing (ICIEF) analysis of a sample processed by an electrophoresis apparatus according to the present invention;

FIG. 9 is a graphic result of an experiment for determining the isoelectric point of a membrane using an electrophoresis apparatus according to the present invention;

FIG. 10 is a graphic result of an imaging isoelectric focusing (ICIEF) analysis of fractions obtained from an egg-white sample using an electrophoresis apparatus according to the present invention;

FIG. 11 is a graphic result of a polyacrylamide gel IEF separation of a sample obtained using an electrophoresis apparatus according to the present invention;

FIG. 12 is another graphic result of another polyacrylamide gel IEF separation of a sample obtained using an electrophoresis apparatus according to the present invention.

### DETAILED DESCRIPTION

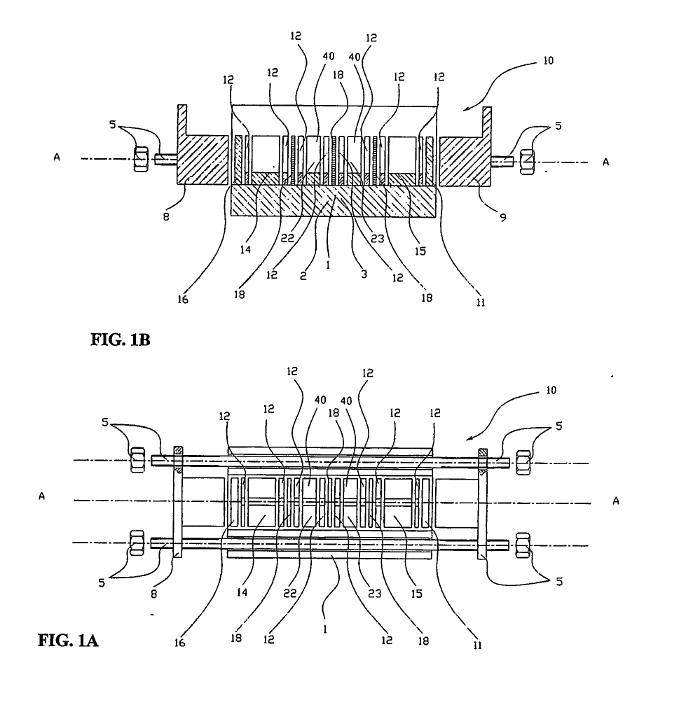

Shown in FIGS. 1A, 1B, 2A, 2B, 3A, and 3B, are preferred embodiments of an electrophoresis apparatus or device 10 for measuring, characterizing, and/or altering a composition of a sample. Device 10 can be used to fractionate a biological sample so as to add or remove at least a portion of a component from a sample solution. More specifically, device 10 can be used in the pre-fractionation of protein samples for proteomic analysis, the preparation of fractions for mass spectral analysis, bioactivity testing, enzymatic analysis and other applications focused on the isolation of components.

In the embodiment shown in FIGS. 1A and 1B, apparatus 10 includes a first element defining or forming anode compartment 14 and a second element defining or forming cathode compartment 15, each of which can be individually inserted and axially spaced apart within housing means 1 along a longitudinal axis A-A. Anode and cathode compartments 14, 15 are each preferably configured to hold at least one electrolyte. In addition, either anode or cathode compartments 14, 15 of apparatus 10 can be further configured to hold at least a portion of the sample to be altered. Each of anode and cathode compartments 14, 15 have means for adding or removing a solution to or from its respective compartment. As shown, anode and cathode compartments 14, 15 can be preferably configured so as to have an opening from the top thereby making anode and cathode compartment 14, 15 accessible for top loading or removal of a solution. Alternatively, anode and cathode compartments can be configured with other structures or alternatively located openings to provide access for adding or removing a solution from the compartments. Preferably respectively disposed within anode and cathode compartments 14, 15 are electrodes (not shown) acting as anode 30 (not shown) and cathode 35 (not shown). Anode and cathode 30, 35 are axially spaced apart substantially along longitudinal axis A-A by a distance d and can be further configured so as to provide an electric field having a direction E substantially parallel to longitudinal axis A-A. The electric field is applied for the purpose of performing the electrophoresis. Anode 30 and cathode 35 can be connected to a power source (not shown), more preferably, anode 30 and cathode 35 can be connected to a variable voltage source having a preferred voltage ranging from about 10 V to about 5000 V, with a current preferably ranging from about 0.01 mA to about 1000 mA. It is to be understood that either compartment 14 or 15 can act as the anode compartment and cathode compartment by connecting the appropriate outlet of the power source to the electrode in the respective compartment functioning as anode 30 and cathode 35.

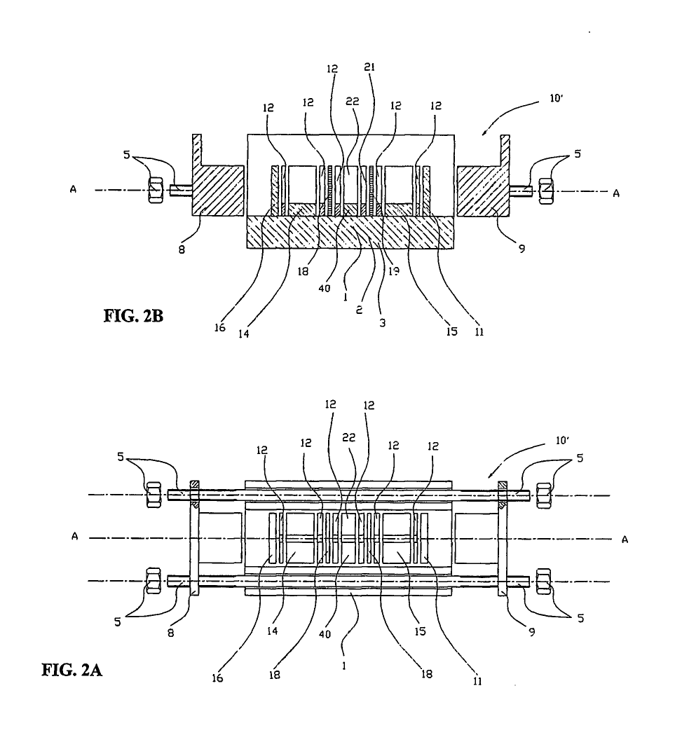

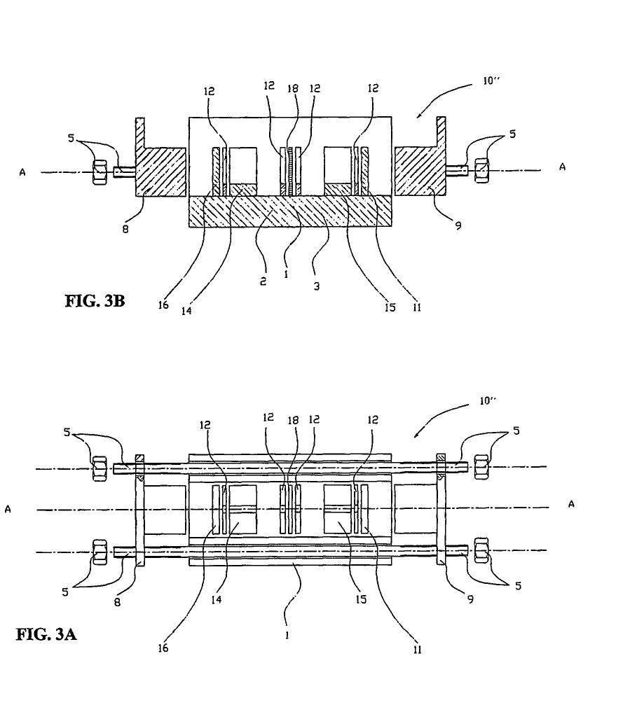

Preferably disposed between anode and cathode compartments 14, 15 and within housing means 1 can be one or more separation elements defining or forming separation wells or compartments 40. Although specifically shown in FIGS. 1A and 1B are first separation compartment 22 and second separation compartment 23, it is to be understood that apparatus 10 can include as many separation compartments 40 as needed for a given electrophoresis application. Each of separation compartments 40, including first and second separation compartments 22, 23 can be configured to hold at least one electrolyte and can be preferably further configured to hold at least a portion of the sample to be altered. Shown in FIGS. 2A and 2B is an alternative embodiment of apparatus 10′ having a single separation compartment, and shown in FIGS. 3A and 3B is yet another embodiment of apparatus 10″ having no separation compartment between anode and cathode compartments 14 and 15.

Housing means 1 orients and seals anode compartment 14, cathode compartment 15 and where provided, separation compartment 40 such that compartments 14, 15 and 40 are substantially aligned along longitudinal axis A-A so as to facilitate communication therebetween in which components of the solution to be altered can migrate between compartments 14, 15 and 40 under the influence of the electric field. In order to prevent fluid loss from compartments 14, 15 and 40 to the environment, apparatus 10 can further include sealing means 12. Preferably, housing means 1 is configured so as to permit top loading of anode, cathode, and separation compartments 14, 15, 40 and sealing means 12 into housing means 1.

Referring again to FIGS. 1A, 1B, 2A, 2B, 3A and 3B, sealing means 12 can be disposed about each of anode and cathode compartments 14, 15 and about separation compartments 40 where present. Each of sealing means 12 is preferably configured to contain ion-permeable barrier 18. Ion-permeable barrier 18 permits electrophoretic migration of selected ions from one compartment 14, 15, 40 to another while substantially restricting convective mixing of solutions contained in compartments 14, 15 and 40.

In order to facilitate the sealing action of sealing means 12, housing means 1 can include axially opposed compression members 8, 9, preferably formed from an electrically insulating, non-brittle, sufficiently rigid material, such as PVC material, that can be axially displaced along longitudinal axis A-A to compress anode and cathode compartments 14, 15, sealing means 12, ion-permeable barriers 18, and where present, separation compartments 40. In addition, axial displacement of opposed compression members 8, 9 facilitates removal and/or replacement of the individual anode, cathode and separation compartments 14, 15, 40, sealing means 12 and ion-permeable barriers 18 from housing means 1. Compression members 8, 9 can directly act on axially opposed end plates 16, 11 which are each preferably engaged with sealing means 12 to transmit the compressive force to the assembled anode and cathode compartments 14, 15, separation compartments 40, sealing means 12 and ion-permeable barriers 18. Compression members 8, 9 can include a threaded rod and nut assembly 5 so as to axially displace compression members 8, 9 along longitudinal axis A-A, however it is to be understood that other means of linear displacement may be provided.

Preferably, at least a portion of housing means 1 is made from a material having a thermal conductivity greater than about 1 W/mK, and a specific heat of greater than about 100 J/kgK, preferably greater than about 250 J/kgK, and especially greater than about 500 J/kgK. Referring to FIGS. 1A, 2A, and 3A housing means 1 can include insulating plate 2 preferably formed from alumina (not shown) and base plate 3 preferably formed from aluminum (not shown) and a cover (not shown). Preferably, anode, cathode and separation compartments 14, 15, 40 and sealing means 12 and ion-permeable barriers 18 are located on insulating plate 2 (not shown). Insulating plate 2 can electrically isolate base plate 3 from each of anode, cathode and separation compartments 14, 15, 40 and sealing means 12 and ion-permeable barriers 18. Moreover, insulating plate 2 (made of alumina) can act as a heat sink during the electrophoresis operation of apparatus 10, 10′ and 10.″ More preferably, the material forming housing 1 can be alumina, aluminum nitride, zirconia, zirconium nitride, boron nitride, silicon nitride, silicon carbide, ceramics, fused silica, quartz, glass or other ceramic materials or any combination thereof. Moreover, base plate 3 (made of aluminum or stainless steel or other suitable metal) can also act as a heat sink during the electrophoresis operation of apparatus 10, 10′ and 10″.

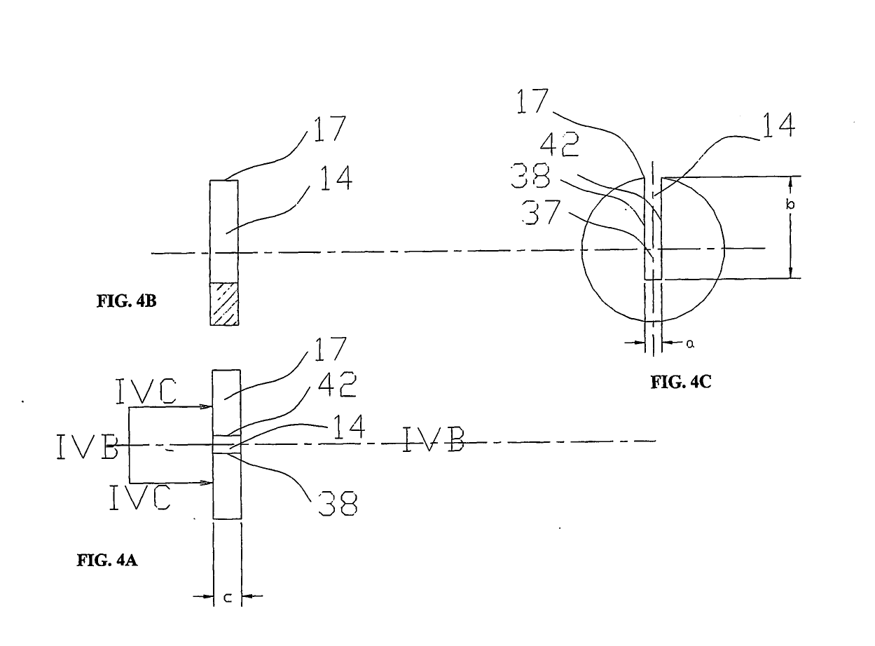

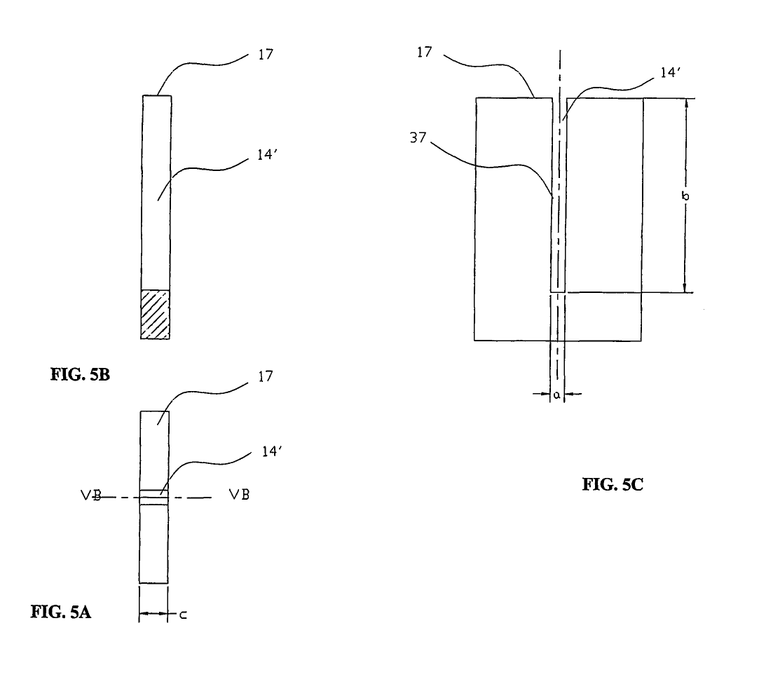

FIGS. 4A, 4B, and 4C and FIGS. 5A, 5B, and 5C are varying views of preferred embodiments of removable anode compartment 14 and cathode compartment 15 of apparatus 10, 10′, 10″ and of separation compartment 40 of apparatus 10, 10′. Anode, cathode and separation compartments 14, 15 and 40 can be formed from alumina, aluminum nitride, zirconia, zirconium nitride, boron nitride, silicon nitride, silicon carbide, ceramics, fused silica, quartz, glass or other ceramic materials or any combination thereof, so that heat generated during electrophoresis is dissipated to the structural material of compartments 14, 15 and 40 to insure that the components in the sample contained within compartments 14, 15 and 40 are not unduly heated. As a result, the need to provide external active (forced) cooling of either the electrolyte or the sample solution can be greatly mitigated, and the electrophoretic power used to operate apparatus 10, 10′ and 10″ can be increased. The undesirable surface characteristics of alumina, zirconia, etc., (variable zeta potential, strong adsorptive binding of proteins) can be easily modified by post-manufacturing surface treatment well known in the art, such as by covalent or noncovalent binding of monomolecular layers or very thin films of protein-binding inhibitors, e.g., hydrophilic organic materials or polymers, onto the surfaces that are exposed to solutions. However, it should be understood that other electrical insulating materials having a relatively high thermal conductivity and specific heat can be used as well. More specifically, the material used to form any individual anode, cathode and separation compartment 14, 15 and 40 have heat transfer properties including a thermal conductivity higher than about 1 W/mK, preferably higher than about 10 W/mK, especially higher than about 20 W/mK and having a specific heat higher than about 100 J/kgK, preferably higher than about 250 J/kgK, and especially higher than about 500 J/kgK.

Specifically shown in FIGS. 4A, 4B and 4C is an illustrative embodiment of anode compartment 14 defined by first element of apparatus 10 as being a substantially circular cylindrical disk-like member. However, other geometries of the first element defining anode compartment 14 are possible, for example, as seen in the illustrative embodiment of FIGS. 5A, 5B and 5C, showing an alternative embodiment of the first element defining anode compartment 14′ as being substantially rectangular in cross-section. Shown more specifically in each of FIG. 4A is a top view of the first element having an upper surface 17. Anode, cathode and separation compartments 14, 15 and 40 can be preferably formed by a grinding operation, but other techniques are possible, for example, casting or molding. Alternatively, where a large number of anode, cathode and separation compartments 14, 15, 40 are to be produced from alumina, compartment 14, or 40 can be formed prior to firing of the alumina.

As seen in FIGS. 4A, 4B, 4C and 5A, 5B, and 5C, anode compartment 14, 14′ is preferably accessible through upper surface 17 so as to permit top loading of a sample or electrolyte solution into compartment 14. Referring to FIGS. 4A, 4B, 4C and 5A, 5B and 5C, anode compartment 14, 14′ is preferably defined by a width or first characteristic dimension “a” a depth or second characteristic dimension “b” and a length or third characteristic dimension “c”. First dimension a and second dimension b define a preferably substantially rectangular cross-section area 37 that is substantially orthogonal to longitudinal axis A-A when, for example, anode compartment 14 is inserted in housing 1. However, other cross-sectional geometries are possible. Moreover, for example, when anode compartment 14 is inserted in housing 1, first dimension a is preferably orthogonal to longitudinal axis A-A or the direction E of the electric field, second dimension b is preferably substantially orthogonal to both the first dimension a and the direction E of the electric field and third dimension c is preferably substantially parallel to the direction E of the electric field along longitudinal axis A-A. In addition, first and second dimensions a, b define an aspect ratio of anode compartment 14 as a ratio of first dimension a to second dimension b. First and second dimensions a and b are preferably selected such that the aspect ratio of anode compartment 14 is less than one. Preferably, the aspect ratio is less than about ½, more preferably the aspect ratio is less than about ⅕, yet more preferably the aspect ratio is less than about 1/10 and even more preferably the aspect ratio is less than about 1/20.

It is to be understood that cathode compartment 15 and any number of separation compartments 40 of apparatus 10, 10′ or 10″ can be independently similarly or variably configured in a manner as described herein with respect to anode compartment 14. More specifically, the aspect ratio of anode compartment 14 can be different from the aspect ratio of cathode compartment 15 and/or separation compartments 40 by varying first and second dimensions a, b of the respective compartments provided the aspect ratio of the respective compartments remains less than one. In a preferred embodiment, separation compartment 40 can be formed by grinding a 1.5 mm wide, 5 to 45 mm deep groove into 99.8% nonporous alumina blocks. Alternatively, grooves can be formed in alumina blocks as thin as 0.25 mm and as thick as 2.5 mm.

Preferably first dimension a and third dimension c are minimized. Minimizing first dimension a can in turn minimize the distance in the solution through which heat can be conducted to the wall of anode compartment 14, cathode compartment 15 and/or separation compartment 40. Minimizing third dimension c can mean that for a given applied potential, the electric field strength, and consequently the electrophoretic migration velocities of the components of the sample being processed are high, thus reducing the required separation time. Moreover, by minimizing third dimension c, i.e., the migration distance in a particular compartment, the overall distance from anode compartment 14 to cathode compartment 15 is minimized and therefore the separation time in processing the sample is once again further reduced. For example, all else being equal, if one replaced a 9 mm I.D., 10 mm long cylindrical separation compartment (with a volume of approximately 636 μl) by a 2 mm by 2 mm by 154 mm rectangular well with a volume of approximately 616 μl (migration distance×width×height of the well), the separation time would decrease about 25-fold (five times due to the reduced migration distance and five times due to the five-fold higher electric field strength for a constant applied potential). Additional benefits would accrue from the smaller temperature rise in the separation well brought about by the smaller heat conduction distance (4.5 mm vs. 1 mm). Preferably, so as to facilitate minimization of first and third dimensions a, c, apparatus 10, 10′, 10″ is preferably configured such that compartments, 14, 15, 40, sealing means 12 and ion-permeable barriers 18 are substantially axially aligned within housing means 1.

Again referring to FIGS. 4A, 4B, 4C and 5A, 5B, and 5C, shown is anode compartment 14, 14′ having first dimension a. First dimension a is preferably less than about 5 mm, more preferably less than about 3 mm, and even more preferably less than about 1 mm. The length of first dimension a can be varied, e.g., by the grinding operation forming anode compartment 14. For example, forming compartment 14 using a jig with grinding wheels of different thickness allows for flexible changing of first dimension a. Preferably, as shown, walls 38, 42 are parallel with respect to one another. Alternatively, walls 38 and 42 can be tapered with respect to one another.

Third dimension c defines the migration distance of a component through anode compartment 14, cathode compartment 15 or separation compartment 40. Referring to FIGS. 1A, 2A, and 3A, third dimension c of anode, cathode compartments 14, 15 and where applicable, any one of separation compartments 40 in apparatus 10, 10′ and 10″ can be either substantially equal or alternatively vary with respect to one another. Preferably, third dimension c of separation compartments 40 is less than about half the distance d between anode 30 and cathode 35. More preferably, third dimension c of separation compartment 40 is about less than ⅓ the distance d between anode 30 and cathode 35. An apparatus 10, 10′ having separation compartments with varying third dimensions c so as to vary the migration distances in the compartments, can provide flexibility in designing the shape of a pH gradient in the apparatus 10, 10′ and can further accommodate major components in larger volumes and minor components in smaller volumes. Moreover, the ability to have separation compartments 40 with varying third dimensions c can also provide a means to concentrate desired components into smaller volumes. Accordingly, where apparatus 10, 10′ can perform the electrophoresis process with partially filled wells or compartments 14, 15 and/or 40, samples of widely different volumes can be handled in the same device.

Second dimension b or depth of the compartment permits the use of open (from the top) compartments 14, 15 or 40, and provides for variable (partial) filling of compartments 14, 15 or 40 between zero and their respective full volume. There is no theoretical limit to the magnitude of second dimension b of the separation compartment orthogonal to the directions of both the electric field and first dimension of the compartment. Second dimension b can be varied to increase or decrease the required maximum reception volume of compartment 14, 15 or 40, without degrading the separation speed or the thermal characteristics of apparatus 10, 10′, 10″. Second dimension b can be varied by varying the dimensions of the material used to form compartment 14, 15 or 40, in conjunction with control of the grinding operation forming compartment 14, 15 or 40. Second dimension b can be as shallow as 5 mm and as deep as 40 mm. Shown in FIGS. 4C and 5C, first dimension a is defined by the distance between walls 38, 42 defining compartment 37. Preferably as shown, walls 38, 42 are parallel with respect to one another. Alternatively, walls 38, 42 can be tapered with respect to one another.

First dimension a, second dimension b and third dimension c of each anode compartment 14, cathode compartment 15, and separation compartment 40 defines a reception volume for each to hold a volume of solution containing a sample component and/or an electrolyte. Preferably, anode and cathode compartment 14, 15 and where applicable, separation compartment 40, of apparatus 10, 10′, 10″ can receive a small volume of a solution containing an electrolyte and/or a sample component, the volume being less than about 5 ml, preferably less than about 2 ml, and more preferably between about 0.5 ml to about 0.001 ml.

In one alternative embodiment (not shown) of apparatus 10 shown in FIGS. 1A and 1B, apparatus 10 can include at least a first separation compartment 22 and at least a second separation compartment 23 having a reception volume greater than the reception volume of first separation compartment 22. Preferably, the reception volume of anode compartment 14 and the reception volume of cathode compartment 15 are greater than the reception volumes of first and second separation compartments 22, 23. In this embodiment, walls 38, 42 of anode compartment 14 and cathode compartment 15 are preferably tapered relative to longitudinal axis A-A so as to produce a smooth transition between anode and cathode compartments 14, 15 to first and second separation compartments 22, 23.

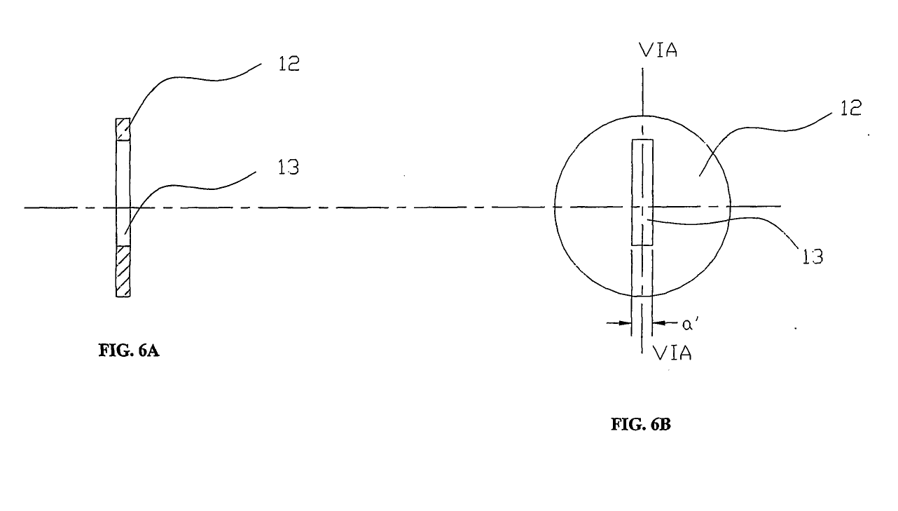

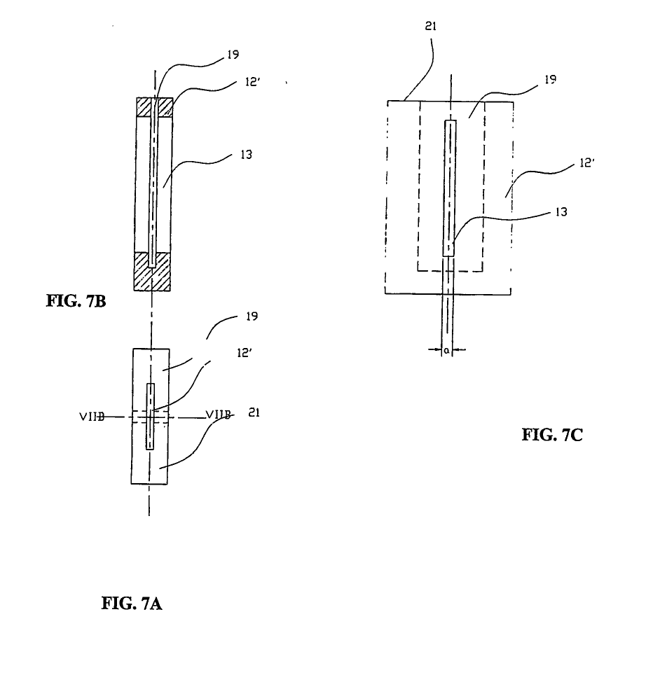

Referring again to FIGS. 1A, 1B, 2A, 2B, 3A, and 3B, apparatus 10, 10′ and 10″ can include sealing means 12 disposed about or in between each anode compartment 14, cathode compartment 15 and where applicable, separation compartments 40 of apparatus 10, 10′ and 10″. Shown in FIGS. 6A, 6B, 7A, 7B and 7C are preferred embodiments of sealing means 12. In FIGS. 6A and 6B, sealing means 12 has a preferably substantially cylindrical disk shape, preferably made of silicone. Alternatively, sealing means 12 can be made from any water insoluble polymer, natural or synthetic, for example including, but not limited to, polyethylene, polypropylene, polyisobutylene, polyalkylenes, polyfluorocarbons, poly(dimethylsiloxane), poly(dialkylsiloxane), poly(alkylarylsiloxane), poly(diarylsiloxane), poly(ether ether ketones) or a combination thereof. Sealing means 12 further includes an opening 13 for providing an access through which ions present in a solution in anode and cathode compartments 14, 15 and where present, separation compartments 40 in apparatus 10, 10′ and 10″ can migrate to and access ion-permeable barrier 18. Opening 13 is preferably substantially rectangular and includes a first characteristic dimension a′ substantially corresponding to first dimension a of anode compartment 14, cathode compartment 15 and where present, separation compartment 40. Shown in FIGS. 1A, 2A, and 3A, preferably disposed between adjacent sealing means 12 are ion-permeable barriers 18. Sealing means 12 can be configured to position, locate or contain ion-permeable barrier 18 within opening 13 of sealing means 12.

Other geometries of sealing means 12 are possible. A preferred alternative embodiment of sealing means 12 is shown in FIGS. 7A, 7B and 7C as 12′. Sealing means 12′ is preferably formed from two silicone sheets joined together so as to form a pouch 19 for holding, containing and/or locating ion-permeable barrier 18. Pouch 19 can further effectively eliminate or significantly reduce the wicking action of the membrane forming ion-permeable barrier 18. Sealing members 12′ and pouch 19 are preferably formed by adhesively joining two silicone sheets together around a removable pouch-defining shim (not shown) or by polymerizing the silicon material around a removable pouch-defining shim (not shown) to form pouch 19. The two silicone sheets used to form sealing means 12′ are preferably pre-cut 0.5 mm or 0.25 mm thick silicone sheets. Alternatively, sealing means 12′ can be made from any water insoluble polymer, natural or synthetic, for example including, but not limited to, polyethylene, polypropylene, polyisobutylene, polyalkylenes, polyfluorocarbons, poly(dimethylsiloxane), poly(dialkylsiloxane), poly(alkylarylsiloxane), poly(diarylsiloxane), poly(ether ether ketones) or a combination thereof. After sealing means 12′ is formed, the shim is removed leaving pouch 19 for location of ion-permeable barrier 18. Pouch 19 is accessible from upper surface 21 of sealing means 12′ so that ion-permeable barrier 18 can be loaded into pouch 19 from the top of sealing means 12.′ Alternatively, ion-permeable barrier 18 can be completely encased in pouch 19 of sealing means 12′, allowing it to communicate with its environment only through opening 13. Alternatively, sealing means 12′ can be cast or molded. Furthermore, the ability to create all seals at once, rather than one by one, reduces the required minimum structural distance in the direction of the electric field.

Sealing means 12′ includes an opening 13 for providing an access through which ions in a solution contained in anode compartment 14, cathode compartment 15 and where present, separation compartment 40 can migrate to and access ion-permeable barrier 18. Opening 13 is preferably substantially rectangular and includes a first characteristic dimension a′ substantially corresponding to first dimension a of anode compartment 14, cathode compartment 15 and where present, separation compartment 40.

Ion-permeable barrier 18 facilitates alteration by electrophoresis of a composition of a sample contained in one or more of anode compartment 14, cathode compartment 15 and separation compartment 40 of apparatus 10, 10′, 10″ of FIGS. 1A, 2A, and 3A, respectively. Moreover, ion-permeable barrier 18 eliminates or mitigates convective mixing of the contents of adjacent anode, cathode and separation compartments 14, 15 and 40. Ion-permeable barrier 18 can be a membrane having a defined pore size and pore size distribution for size-based and charge-sign-based electrophoretic separation of the sample components. Alternatively, ion-permeable barrier 18 can be an isoelectric membrane suitable for isoelectric trapping (EET) separations. Ion-permeable barrier 18 can also be configured so as to be essentially free of weekly acidic functional groups or weakly basic functional groups or anionic functional groups or cationic functional groups. Ion-permeable barrier 18 can also be configured to be an isoelectric membrane suitable for isoelectric trapping (IET) separations and have a defined pore size and pore size distribution.

For size-based separations, ion-permeable barrier 18 is preferably made from polyacrylamide and preferably has a nominal molecular mass cut-off from about 1 kDa to 1500 kDa. The molecular mass cut-off of the membrane material selected for ion-permeable barrier 18 will depend on the sample being processed and the type of components in the sample.

For IET-based separations, at least one ion-permeable barrier 18 can be an isoelectric membrane formed from any suitable material. Examples include, but are not limited to, copolymers formed from acrylamide, bisacrylamide, acrylamido weak electrolytes and acrylamido strong electrolytes. Preferably, the membranes are thin or ultra-thin, having a thickness of about 2 mm or less, preferably about 1 mm or less, and especially about 0.2 mm or less. Where ion-permeable barrier 18 is an isoelectric membrane, barrier 18 is provided with a concentration of buffering species in the membrane material. The isoelectric membrane forming ion-permeable barrier 18 does not have to be thick to provide adequate buffering capacity. As long as the isoelectric membrane forming ion-permeable barrier 18 can mitigate convective mixing between the contents of adjacent compartments 14, 15 and 40, the thinner the membrane, the shorter the distance the ampholytic components must travel. Therefore, thin isoelectric membranes can lead to shorter separation times. Also, for all else being equal, the thinner the isoelectric membrane, the less potential drops across it, and thus the less power is consumed to effect the electrophoretic separation. Additionally, most solutions used for rehydration of the IPGIEF strips contain 0.1-1% carrier ampholytes. In EEF pre-fractionation of proteomics samples, the fractions typically do not contain a single isoelectric species with a single pI value, rather many components that cover a relatively wide pI range (0.1<pI<2). This means that in the fractions, even at the end of the separation, the carrier ampholyte and ampholytic sample molecules are typically not in their isoelectric state, but are protonated and deprotonated by each other. This also means that in these fractions the ionic strength is higher than at the end of an IET separation in which pure, single components are produced in a compartment. If, due to the improved heat dissipation performance of electrophoresis apparatus 10 one could add, in a sufficiently high concentration, carrier ampholytes or auxiliary isoelectric buffers to the sample prior to electrophoresis, one could significantly increase the ionic strength in the respective fractions. This would improve protein solubility and increase the total amount of material that can be loaded or processed in the given volume of the system.

The characteristics of ion-permeable barrier 18 used depend on the sample and the type of separation or treatment contemplated. Within a single apparatus 10, 10′ or 10″, ion-permeable barriers 18 used may each be variably configured in a manner described herein to suit the electrophoresis application as needed. Ion-permeable barriers 18 or membranes can be purchased for use in the apparatus or made by the user prior to carrying out the desired electrophoresis run.

Referring again to FIGS. 1A, 2A and 3A, to assemble electrophoresis apparatus 10, 10′ and 10″, anode and cathode compartments 14, 15 and where provided, separation compartments (wells) 40, sealing means 12 and ion-permeable barriers 18 preferably installed in pouches 19 can be placed into housing means 1 preferably from above. Once compartments 14, 15, 40, sealing means 12 and ion-permeable barriers 18 are in place, wing nuts 5 are turned gently until they become finger tight over compression members 8,9 to create the seals. Compartments 14, 15, 40 are then filled with deionized water for a brief leak test. Once the system passes the leak test, anode and cathode compartments 14, are filled with the respective anolyte and catholyte solutions, separation compartments 40 are preferably filled with the sample and where provided, an electrolyte, anode 30 and cathode 35 are respectively lowered into anode and cathode compartments 14, 15 and the electrophoretic potential is applied. In the case of an IET separation, the IET separation can be carried out using either constant potential, constant current or constant power input. Once the IET separation is complete (as indicated by the time course of the potential or the current), power is turned off and the contents of compartments 14, 15, 40 are removed for subsequent analysis or use.

In one exemplary assembled embodiment of an electrophoresis apparatus 10, unfilled polycarbonate, for example, LEXAN® available from BOEDEKER PLASTICS, TX, is used to form housing means 1 and a ½ inch diameter borosilicate glass rod is used to form five separation compartments 40, each having a holding volume of 50 μl. Ion-permeable barriers 18 are formed from isoelectric membranes which are installed between sealing means 12 formed from silicone disks which reduce solution loss from membrane wicking. Such an assembled apparatus 10 could be used for the separation of low molecular weight pI markers and proteins and for UV-active carrier ampholyte-based membrane characterization. Using a surface treatment with a hydrophilic polymer on sealing means 12 can further reduce leaking problems and mitigate electroosmotic flow.

In another exemplary embodiment of an electrophoresis apparatus 10, housing means 1 is preferably constructed from LEXAN® and seven separation compartments 40 are preferably formed from a ¾ inch diameter borosilicate glass rod. Each separation compartment 40 defines a receiving volume of 150 μl. Ion-permeable barriers 18 are preferably isoelectric membranes installed in sealing means 12 including circular silicone pouches 19 that completely prevent liquid loss by wicking. Such an assembled apparatus 10 can be used for the separation of low molecular weight pI markers and proteins and for UV-active carrier ampholyte-based membrane characterization.

In another exemplary embodiment of an electrophoresis apparatus 10, housing means 1 is preferably constructed from LEXAN® and six separation compartments 40 are preferably formed from rectangular ½×¼×1 inch, nonporous, 99.8% alumina blocks. Each separation compartment 40 defines a second dimension b of about 5 mm. Such an assembled apparatus 10 can be used for IET desalting, the separation of low molecular weight pI markers and proteins and for UV-active carrier ampholyte-based membrane characterization. Using a surface treatment with a hydrophilic polymer on sealing means 12 can further reduce leaking problems and practically eliminate electroosmotic flow.

In another exemplary embodiment of an electrophoresis apparatus 10, housing means 1 is preferably constructed from LEXAN® and ten separation compartments 40 are preferably formed from rectangular, ½×¼×1 inch, nonporous, 99.8% alumina blocks, each having a second dimension b being about 18 mm deep. Such an assembled apparatus 10 can be used for IET desalting, the separation of low molecular weight pI markers and proteins, for UV-active carrier ampholyte-based membrane characterization, and for the selection of the appropriate isoelectric membranes for larger scale membrane-based IET separations.

In yet another exemplary embodiment of an electrophoresis apparatus 10, housing means 1 is preferably constructed from LEXAN® and twenty separation compartments 40 are preferably formed from rectangular, 2×35×55 mm, nonporous alumina blocks, each defining second dimension b as being about 40 mm deep. Such an assembled apparatus 10 can be used for IET desalting, the separation of low molecular weight pI markers and proteins, for UV-active carrier ampholyte-based membrane characterization and for the selection of the appropriate isoelectric membranes for larger scale membrane-based IET separations.

The method of altering a composition of a sample by electrophoresis using an apparatus 10, 10′ or 10″ includes selecting an ion-permeable barrier 18 for use between the anode and cathode compartments based upon the given application. Upon providing anode and cathode compartment 14, 15 with the requisite electrolyte, the sample can be added to one or more of compartments 14, 15 and 40. Alternatively, using an apparatus 10, 10′ or 10″, a sample can be added to one or more compartments 14, 15, or 40 and an electrolyte can be added to any compartment 14, 15, or 40 that does not contain the sample. Alternatively, using apparatus 10, 10′, or 10″ both a sample and an electrolyte can be added to one or more of compartments 14, 15, or 40 and an electrolyte can be added to any compartment 14, 15, or 40 that does not contain the sample. Subsequently, an electrophoretic direct current between the anode and the cathode can be provided by applying an electric potential between the anode and the cathode so as to cause a part of a component of the sample being processed to transfer across an ion-permeable barrier 18.

In a first preferred method of processing a sample using an electrophoresis apparatus 10, 10′ or 10″, all ion-permeable barriers 18 inter-disposed in housing means 1 are preferably anti-convective isoelectric barriers. Selecting ion-permeable barriers 18 of this type produces fractions with predetermined pI ranges, i.e., the system is operated in pure IET mode. The pI cuts can be as narrow or as broad as desired, depending on the characteristics of the sample and the objective of the electrophoretic separation, i.e., prefractionation, selective component removal and/or enrichment of a component of the sample being processed. Fractionation can be achieved in the presence or absence of carrier ampholytes and auxiliary isoelectric buffers. This method of processing is especially flexible when compartments 14, 15 and 40 are variable within a single apparatus 10, 10′, 10″ with respect to first characteristic dimension a.

In the second or alternative method of processing a sample using an electrophoresis apparatus 10, 10′ or 10″, ion-permeable barriers 18 adjacent to anode compartment 14 and cathode compartment 15 are preferably anti-convective, isoelectric barriers. All other ion-permeable barriers 18 of apparatus 10, 10′ are preferably anti-convective, ion-permeable, non-isoelectric membranes. The fractions produced in the anode, cathode and/or separation compartments 14, 15, 40 still have distinct pI ranges. However, the respective pI ranges are not known a-priori, rather they depend on the composition of the solution, i.e., the relative amount of the carrier ampholytes, if used, the isoelectric auxiliary agent(s), if used, and the analytes (pure autofocusing mode). The advantage of this method or processing is that it allows for the production of fractions with pI ranges for which no isoelectric membranes are available. The drawback of this second method can be that the pI range boundaries associated with individual compartments 40 cannot be defined by the user ahead of the time. This second method of processing a sample is especially flexible when apparatus 10, 10′ includes a large number of separation compartments 40, each with a very small third characteristic dimension c.

In another or third method of processing a sample using an electrophoresis apparatus 10 having at least two separation compartments 40, ion-permeable barriers 18 adjacent to anode compartment 14 and cathode compartment 15 are preferably anti-convective isoelectric barriers, at least one ion-permeable barrier 18 inter-disposed between separation compartments 40 is preferably an anti-convective, isoelectric barrier, and at least one other ion-permeable barrier 18 is preferably an anti-convective, non-isoelectric barrier. Using this alternative method, the fractions produced in anode, cathode and/or separation compartments 14, 15, 40 also have distinct pI ranges: for some of them the pI range depends on the pI values of the isoelectric membranes delimiting the individual separation compartments 40, for others it depends on the composition of the solution, i.e., the relative amount of the carrier ampholytes, if used, the isoelectric auxiliary agent(s), if used, and the analytes (mixed IET—autofocusing mode). This third or alternative method of processing a sample is advantageous when the pI boundaries for a major sample component are not known exactly, but one still would like to isolate minor components with slightly lower and slightly higher pI values than the pI value of a major component. The drawback of the method is that the exact pI range boundaries of all the fractions cannot be defined by the user ahead of time. The third operation mode also benefits from the use of a relatively large number of separation compartments 40 having a very small third characteristic dimension c.

In yet another or fourth method of processing a sample using an electrophoresis apparatus 10, 10′, ion-permeable barriers 18 adjacent to anode compartment 14 and cathode compartment 15 are preferably anti-convective, isoelectric barriers. The solutions in anode, cathode and separation compartments 14, 15, 40 can contain one or more isoelectric auxiliary agents. Additionally, at least one of ion-permeable barriers 18 of apparatus 10, 10′ is preferably an anti-convective barriers having a characteristic, size-dependent permeability. This alternative method of processing a sample allows for a size-based fractionation of components, especially when the amounts of sample components are relatively small compared to that of the isoelectric auxiliary agent(s) retained in the system by isoelectric trapping.

In another alternative or fifth method of processing a sample using an electrophoresis apparatus 10, 10′, 10″ all ion-permeable barriers 18 are anti-convective and have a characteristic size-dependent permeability. At least one of anode, cathode and separation compartments 14, 15 and 40 can contain a solution of one or more isoelectric auxiliary agents. This method can be used for a rapid desalting of the sample or a size-based or charge-sign-based separation of its components. In a preferred method of desalting using the fifth method of processing a sample in apparatus 10, 10′, the smaller the number of separation compartments 40 provided, the faster the desalting, though the use of at least one separation compartment 40 adjacent to each of anode and cathode compartments 14, 15 might reduce the extent of protic shock for the sample components.

In yet another alternative or sixth method of processing a sample using an electrophoresis apparatus 10, (known as a matrix deployment method), a plurality of separation compartments 40 and inter-disposed isoelectric ion-permeable barriers 18 ranging between a low and a high pI are provided, e.g., twelve separation compartments 40 and ten inter-disposed isoelectric ion-permeable barriers 18 ranging between a pI of 2 to a pI of 12 are provided, where the pI of each successive ion-permeable barrier 18 increases by 1.0. A complex biological sample, for example, a sample intended for proteomic analysis, is loaded into one or more of the ten separation compartments of first apparatus 10. Anode and cathode compartments 14, 15 of first apparatus 10 are filled with an anolyte and catholyte, respectively. In this preferred method of use of electrophoresis apparatus 10, the fractions produced in compartments 40 define the ten rows of a separation matrix.

After performing an IET separation for 10 to 30 minutes using first apparatus 10, the content of each separation compartment 40 is transferred, preferably simultaneously, into ten separate apparatuses 10, each having an anode compartment, a cathode compartment and ten separation compartments 40. The ten apparatuses 10 in the second set of apparatuses define ten columns of the separation matrix. Accordingly, separation compartments 40 present in this second set of apparatuses 10 define the elements of the separation matrix. Ion-permeable barriers 18 adjacent to anode and cathode compartments 14, 15 in apparatus 10 defining the columns of the separation matrix have the same pI values as ion-permeable barriers 18 inter-disposed between the respective separation compartments 40 of first apparatus 10 defining the rows of the separation matrix. Thus, e.g., ion-permeable barrier 18 between the anode compartment and the first separation compartment of apparatus 10 defining the first column of the separation matrix has a pI of 2, and ion-permeable barrier 18 between the cathode compartment and the last separation compartment of apparatus 10 defining the first column of the separation matrix has a pI of 3; ion-permeable barrier 18 between the anode compartment and the first separation compartment of apparatus 10 defining the second column of the separation matrix has a pI of 3, and ion-permeable barrier 18 between the cathode compartment and the last separation compartment of apparatus 10 defining the second column of the separation matrix has a pI of 4; ion-permeable barrier 18 between the anode compartment and the first separation compartment of apparatus 10 defining the third column of the separation matrix has a pI of 4, and ion-permeable barrier 18 between the cathode compartment and the first separation compartment of apparatus 10 defining the third column of the separation matrix has a pI of 5; etc. In each apparatus 10 defining the columns of the separation matrix, separation compartments 40 are isolated from each other by anti-convective, non-isoelectric ion-permeable barriers 18. Thus, a temporally stable pH gradient is formed during the second electrophoretic separation across separation compartments 40 in each apparatus 10 defining the columns of the separation matrix, with the shape of the respective pH gradients depending on the relative amounts of the carrier ampholytes, where used, the auxiliary isoelectric buffers, where used, and the sample constituents. Thus, separation compartments 40 in the first and second sets of apparatuses 10 define the elements of the separation matrix (10×10=100), and each respective separation compartment 40 contains fractions with a pI range of about 0.1. The resulting fractions can then be directly analyzed by mass spectroscopy, used for further research or digested and analyzed by mass spectrometry as common in proteomics to identify the constituent proteins.

If needed, the fractions can be subdivided further, preferably in another electrophoresis apparatus 10 wherein ion-permeable barriers 18 having a characteristic, size-dependent permeability are used in a manner substantially similar to the sixth method of processing a sample as described above. The resulting fractions can then be directly analyzed by mass spectroscopy, used for further research or digested and analyzed by mass spectrometry as common in proteomics to identify the constituent proteins. If needed, the respective digests can also be subjected to a subsequent IET separation in another apparatus 10 to provide fractions containing peptides with similar acidities. Such fractions are preferred for mass spectrometric analysis. This matrix operation mode provides a purely liquid-vein alternative 2DE-MS method for an analysis of the constituents of a complex, proteomic sample.

In an alternative method to the matrix deployment method, the content of each separation compartment 40 from the first IET separation is first stored, then sequentially transferred, ten times, into the ten separation compartments (wells) of the same, sequentially used electrophoresis apparatus 10, and the IET analysis defining the columns of the separation matrix is accomplished over a longer period of time, requiring only a single apparatus 10.

In yet another alternative embodiment of the matrix deployment method described above, a first apparatus 10 having twenty-two separation compartments 40 is assembled using twenty inter-disposed isoelectric ion-permeable barriers 18 having pI values ranging between a pI of 2 to a pI of 12, where the pI of each successive ion-permeable barrier 18 increases by 0.5. A complex biological sample, for example, a sample intended for proteomic analysis, is loaded into one or more of the twenty separation compartments of first apparatus 10. Anode and cathode compartments 14, 15 of first apparatus 10 are filled with an anolyte and catholyte, respectively. In this preferred method of use of electrophoresis apparatus 10, the fractions produced in compartments 40 define the twenty rows of the separation matrix.

After performing an IET separation for 10 to 30 minutes using first apparatus 10, the content of each separation compartment 40 is transferred, preferably simultaneously, into twenty separate apparatuses 10, each having an anode compartment, a cathode compartment and twenty separation compartments 40. This second set of electrophoretic devices, comprised of twenty apparatuses 10, defines the columns of the separation matrix. Accordingly, separation compartments 40 present in this second set of apparatuses 10 define the elements of the separation matrix. Ion-permeable barriers 18 adjacent to anode and cathode compartments 14, 15 in apparatus 10 defining the columns of the separation matrix have the same pI values as ion-permeable barriers 18 inter-disposed between the respective separation compartments of first apparatus 10 defining the rows of the separation matrix. Thus, e.g., ion-permeable barrier 18 between the anode compartment and the first separation compartment of apparatus 10 defining the first column of the separation matrix has a pI of 2, and ion-permeable barrier 18 between the cathode compartment and the last separation compartment of apparatus 10 defining the first column of the separation matrix has a pI of 2.5; ion-permeable barrier 18 between the anode compartment and the first separation compartment of apparatus 10 defining the second column of the separation matrix has a pI of 2.5, and ion-permeable barrier 18 between the cathode compartment and the last separation compartment of apparatus 10 defining the second column of the separation matrix has a pI of 3; ion-permeable barrier 18 between the anode compartment and the first separation compartment of apparatus 10 defining the third column of the separation matrix has a pI of 3.0, and ion-permeable barrier 18 between the cathode compartment and the first separation compartment of apparatus 10 defining the third column of the separation matrix has a pI of 3.5; etc. In each apparatus 10 defining the columns of the separation matrix, separation compartments 40 are isolated from each other by anti-convective, non-isoelectric ion-permeable barriers 18. Thus, a temporally stable pH gradient is formed during the second electrophoretic separation across separation compartments 40 in each apparatus 10 defining the columns of the separation matrix, with the shape of the respective pH gradients depending on the relative amounts of the carrier ampholytes, where used, the auxiliary isoelectric buffers, where used, and the sample constituents. Thus, separation compartments 40 in the first and second sets of apparatuses 10 define the elements of the separation matrix (20×20=400), and each respective separation compartment 40 contains fractions with a pI range of about 0.025. The resulting fractions can then be directly analyzed by mass spectroscopy, used for further research or digested and analyzed by mass spectrometry as common in proteomics to identify the constituent proteins.

If needed, the fractions can be subdivided further, preferably in another electrophoresis apparatus 10 wherein ion-permeable barriers 18 having a characteristic, size-dependent permeability are used in a manner substantially similar to the method of processing a sample as described above. Due to the fine pI resolution, the number of size-based fractions required might be relatively low (e.g., 4 to 6). The resulting fractions can then be directly analyzed by mass spectroscopy, used for further research or digested and analyzed by mass spectrometry as common in proteomics to identify the constituent proteins. If needed, the respective digests can also be subjected to a subsequent IET separation in another apparatus 10 to provide fractions containing peptides with similar acidities. Such fractions are preferred for mass spectrometric analysis. This high resolution matrix operation mode can provide a purely liquid-vein alternative to the 2DE-MS analysis of the constituents of a complex, proteomic sample and is believed to be just as (or more) powerful as the currently used prefractionation-2DE-MS methods, while being more suitable for robotics-based automation.

Another or seventh method of processing a sample includes using an electrophoresis apparatus 10 in which dilute samples or fractions can be concentrated by IET. A preferred apparatus 10 is assembled using separation compartments 40, more specifically, a first separation compartment 22 and at least a second separation compartment 23 smaller that the first separation compartment 22, each compartment disposed between anode compartment 14 and cathode compartment 15. Larger separation compartment 22 is preferably located adjacent to anode or cathode compartment 14, 15 (or both, if two larger separation compartments 22 are used). Preferably, anode and cathode compartments 14, 15 are each relatively large as compared to first and at least second compartments 22, 23. Walls 37, 42 of first separation compartment 22 are preferably tapered, producing a smooth transition between anode and cathode compartments 14, 15 having preferably wider first dimensions a and second separation compartment 23 having preferably narrower first dimension a. To provide adequate potential drop across separation compartments 22, 23, at least one isoelectric buffer is added to the sample to be fractionated. The pI value of the added isoelectric buffer is selected such that the isoelectric buffer is trapped in first separation compartment 22, between isoelectric ion-permeable barriers 18 separating anode and cathode compartments 14, 15 and first separation compartment 22, and isoelectric ion-permeable barrier 18 separating the large volume wells and at least one second smaller separation compartment 23. In another preferred embodiment, simultaneous concentration and fractionation can be achieved using a plurality of separation compartments 40 separated by isoelectric or non-isoelectric ion-permeable barriers 18.

### EXAMPLES

### Example 1

### Fractionation of Low Molecular Weight pI Markers

An electrophoresis apparatus was assembled using six alumina elements that each contain a 40×2×2.5 mm compartment. The anode, cathode and four separation compartments were separated by five ion-permeable barriers made from isoelectric membranes respectively having pI values of: pI=2, pI=3, pI=5, pI=6.5, and pI=9.5. The anode compartment was filled with 60 mM methanesulfonic acid, and the cathode compartment was filled with a mixture of 20 mM lysine and 20 mM arginine. The separation compartment delimited by ion-permeable barriers of pI=2 and pI=3 contained 50 mM IDA. Nominal 200 μl aliquots of a sample containing 2% Pharmalyte 3<pI<10 carrier ampholytes and three pI markers: nicotinic acid (pI=3.2), 4-hydroxy-2-(morpholinomethylene)-benzoic acid (pI=5.8) and epinephrine (pI=9.2) were loaded into each of the separation compartments of the apparatus. The power supply was operated at a constant power of 4 W for 14 min, yielding an initial potential of 213 V, final potential of 575 V, initial current of 16 mA and final current of 7 mA. The separation took a total of 121 Vh.

The content of each well was analyzed by the iCE280 ICIEF system (Convergent Bioscience, Toronto, Canada) before the IET separation and after the IET separation. The respective volume changes, the component peak areas and their ratios are set out in Table 1.

TABLE 1

| | | Vol change | | | | |
|---|---|---|---|---|---|---|
| Well | pI range | (μl) | Marker | Areaᵢₙᵢₜ | Area_{final} | Ratio |
| 1 | pI < 2 | +5 | | | | |
| 2 | 2 < pI < 3 | 0 | | | | |
| 3 | 2 < pI < 3 | −5 | Nic | 16490 | 44630 | 2.71 |
| 4 | 5 < pI < 6.5 | +5 | Morph | 4412 | 12625 | 2.86 |
| 5 | 6.5 < pI < 9.5 | −5 | Epi | 20966 | 57278 | 2.73 |
| 6 | 9.5 < PI | 0 | | | | |

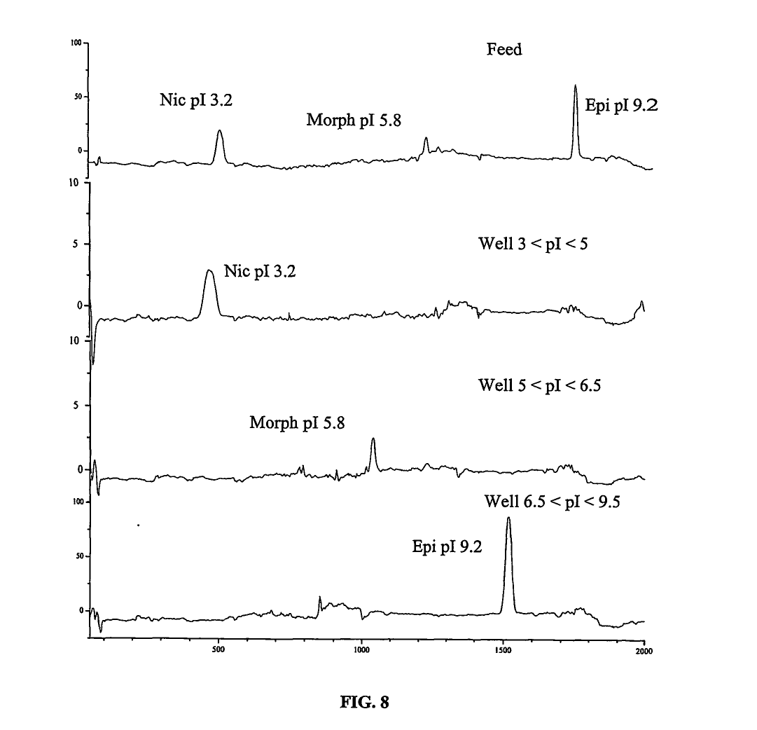

The results of an ICIEF run are shown in FIG. 8. Clearly, the UV-absorbing pI markers were completely moved in 14 min into the wells limited by the appropriate isoelectric membranes.

### Example 2

### Characterization of the pI of an Isoelectric Separation Membrane

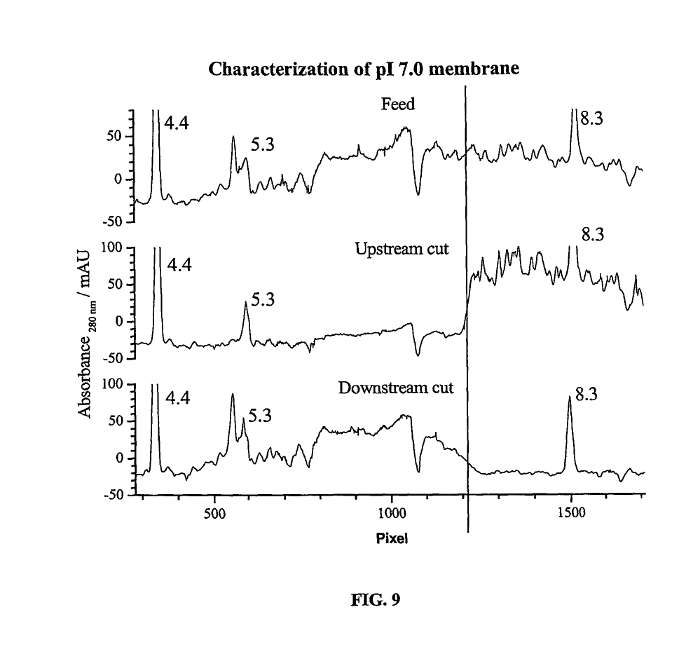

An electrophoresis apparatus was assembled using four alumina elements that each contain a 40×2×2.5 mm separation compartment. The anode, cathode and two separation compartments were isolated by three ion-permeable barriers made from isoelectric membranes, the first of which had a pI value of 2, the second one was the membrane to be tested, and the third one was a membrane with a pI value of 11.5. The anode compartment was filled with 60 mM methanesulfonic acid and the cathode compartment was filled with 60 mM NaOH. Nominal 200 μl aliquots of a sample containing 2% Pharmalyte 3<pI<10 carrier ampholytes and 0.1% UV active carrier ampholytes were loaded into the two separation compartments. The power supply was operated at a constant power of 6 W for 15 min. After IET, the contents of the well adjacent to the anode compartment and the cathode compartment were analyzed by ICIEF using the iCE280 unit. The results are shown in FIG. 9. Clearly, the carrier ampholytes were separated into two fractions indicating that the pI of the isoelectric membrane to be tested was 7.5.

### Example 3

### Fractionation of an Egg-White Sample

An electrophoresis apparatus was assembled using five alumina elements that each contain a 40×2×2.5 mm alumina compartment. The anode, cathode and three separation compartments were isolated by ion-permeable barriers made from isoelectric membranes respectively having pI values of: pI=4; pI=5.6, pI=8.5 and a pI=12. The anode compartment was filled with 50 mM IDA and the cathode compartment was filled with 60 mM NaOH. Nominal 200 μl aliquots of filtered egg white dissolved in 2% Pharmalyte 3<pI<10 carrier ampholytes were loaded into each of the three separation compartments. The power supply was operated at a constant potential of 500 V for 18 min, yielding a final current of 4 mA. After IET separation, the content of each compartment was analyzed by the iCE280 ICIEF system.

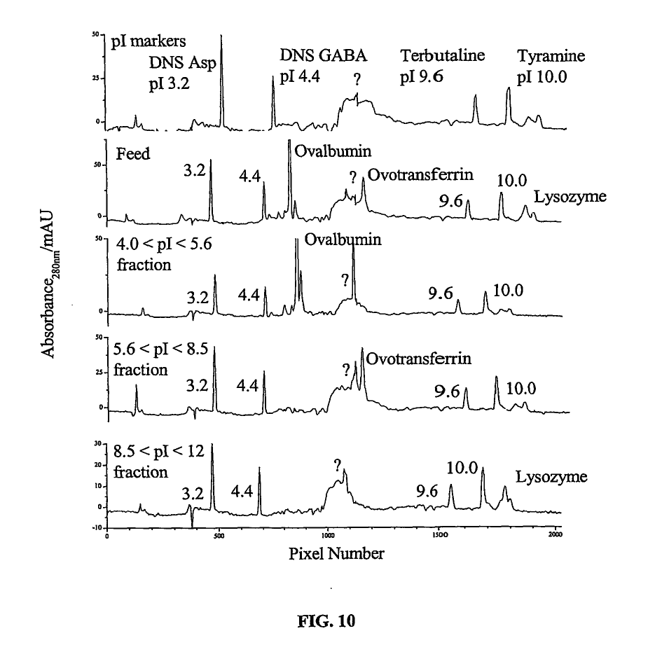

The results are shown in FIG. 10. The top panel is the ICIEF result for the pI markers, the second panel is the egg white feed sample mixed with the pI markers, the third panel is for the 4<pI<5.6 fraction, the fourth panel is for the 5.6<pI<8.5 fraction, and the fifth panel is for the 8.5<pI<12 fraction. The major proteins in each fraction (ovalbumin, ovotransferrin and lysozyme) reach their final destination well in as short a separation time as 18 min.

### Example 4

### Binary Fractionation of a Calf Liver Lysate Sample

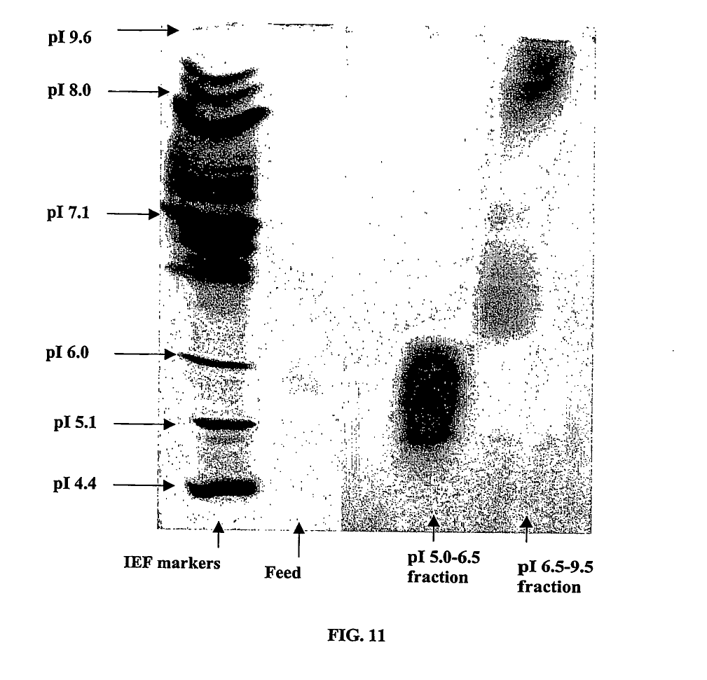

An electrophoresis apparatus was assembled using four alumina elements that each contain a 40×2×2.5 mm compartment. The anode, cathode and two separation compartments were separated by three ion-permeable barriers respectively having pI values of: pI=5, pI=6.5 and pI=9.5. The anode compartment was filled with 60 mM CH₃SO₃H and the cathode compartment was filled with a mixture of 20 mM lysine and 20 mM arginine. Nominal 200 μl aliquots of 0.5 mg/ml calf liver lysate (7 M urea, 2 M thiourea, 4% CHAPS, 3% 3<pI<10 Pharmalyte carrier ampholytes) were loaded into each of the three separation compartments. The power supply was operated at a constant power of 4 W for 15 min, yielding a final current of 5 mA. After IET separation, the content of each compartment was analyzed by IEF using 3<pI<10 IEF gels (Invitrogen). Results of the separation are shown in FIG. 11. There was a very sharp cut between the two protein fractions indicating that the IET separation was complete in as little as 15 min.

### Example 5

### Fractionation of a Calf Liver Lysate Sample

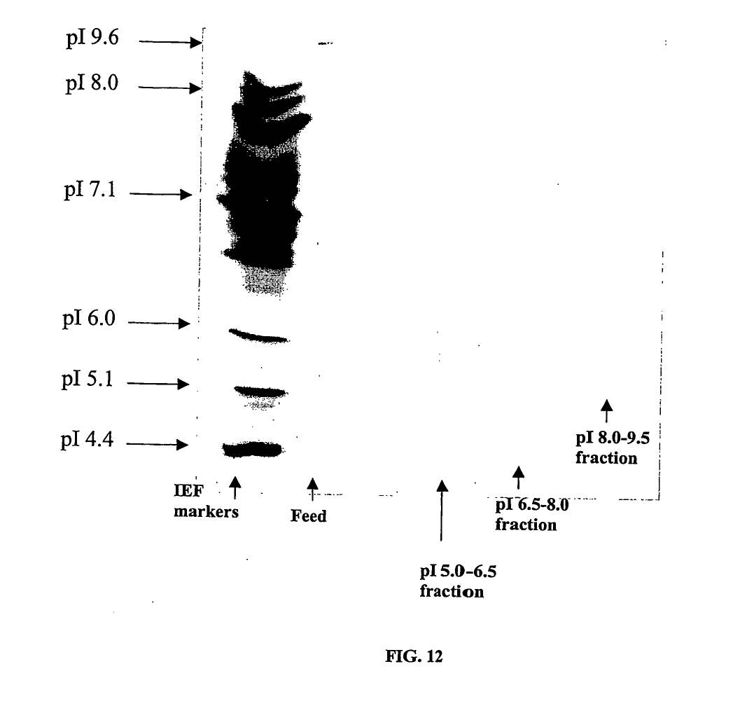

An electrophoresis apparatus was assembled using five alumina elements that each contain a 40×2×2.5 mm compartment. The anode, cathode and three separation compartments were separated by four ion-permeable barriers made from isoelectric membranes respectively having pI values of: pI=3, pI=5, pI=6.5 and pI=9.5. The anode compartment was filled with 60 mM CH₃SO₃H and the cathode compartment was filled with a mixture of 20 mM lysine and 20 mM arginine. Nominal 200 μl aliquots of 0.5 mg/ml calf liver lysate (7 M urea, 2 M thiourea, 4% CHAPS, 3% 3<pI<10 Pharmalyte carrier ampholytes) were loaded into a single separation compartment delimited by ion-permeable barriers of pI=3 and pI=5. The power supply was operated at a constant power of 4 W for 15 min, yielding a final current of 5 mA. After IET separation, the content of each well was analyzed by IEF using 3<pI<10 IEF gels (Invitrogen). Results of the separation are shown in FIG. 12. There was a very sharp cut between the three protein fractions indicating that the IET separation was complete in as little as 25 min.

The electrophoresis apparatus described herein addresses many of the disadvantages of currently used isoelectric pre-fractionation apparatuses and methods such as the inability to tolerate high electric power loads, the need for active cooling, slow separation speeds, inconvenient system set-up and sample handling, and relatively large sample volumes that cannot be varied easily. The apparatus described herein may be used to separate varying volumes of complex samples into multiple fractions, with direct recovery of the fractions for subsequent analytical or biological characterization, in 10 to 30 min, using 5 to 10 W power, without active (forced) external cooling.

While the present invention has been disclosed with reference to certain embodiments, numerous modifications, alterations, and changes to the described embodiments are possible without departing from the sphere and scope of the present invention, as defined in the appended claims. Accordingly, it is intended that the present invention not be limited to the described embodiments, but that it have the full scope defined by the language of the following claims, and equivalents thereof.

What we claim is:

1. An electrophoresis apparatus comprising:
an anode and a cathode, the cathode spaced from the anode so as to define a distance along a longitudinal axis, the anode and cathode further defining an electric field having a direction substantially along the longitudinal axis;
an anode compartment, the anode disposed therein, a cathode compartment, the cathode disposed therein, each of the anode compartment and the cathode compartment being configured to hold at least one electrolyte, at least one of the anode compartment and the cathode compartment being configured to hold at least a portion of a sample, and each of the anode compartment and the cathode compartment including:
means for addition or removal of a solution;
a first compartment dimension, a second compartment dimension, and a third compartment dimension, the first compartment dimension being substantially orthogonal to the direction of the electric field, the second compartment dimension being substantially orthogonal to the direction of the electric field and the first compartment dimension, a ratio of the first compartment dimension and the second compartment dimension defining an aspect ratio of the compartment, and the third compartment dimension being substantially parallel to the direction of the electric field and substantially orthogonal to the first and second compartment dimensions; and
an ion-permeable barrier positioned between the anode compartment and the cathode compartment, the ion-permeable barrier being configured to prevent convective mixing therebetween, wherein
at least a portion of at least one of the anode and cathode compartments is made of an electrically insulating material having a thermal conductivity greater than about 1 W/mK and a specific heat greater than about 100 J/kgK and the aspect ratio of at least one of the anode compartment and the cathode compartment is less than one.

2. The electrophoresis apparatus of claim 1, further comprising sealing means disposed between the anode compartment and the cathode compartment.

3. The electrophoresis apparatus of claim 2, wherein the sealing means is adapted to contain the ion-permeable barrier and provide access of ions to the ion-permeable barrier.

4. The electrophoresis apparatus of claim 3, wherein the sealing means is made of a water insoluble polymer, the polymer being natural or synthetic.

5. The electrophoresis apparatus of claim 4, wherein the water insoluble polymer is selected from the group consisting of polyethylene, polypropylene, polyisobutylene, polyalkylenes, polyfluorocarbons, poly(dimethylsiloxane), poly(dialkylsiloxane), poly(alkylarylsiloxane), poly(diarylsiloxane), poly(ether ether ketones) or a combination thereof.

6. The electrophoresis apparatus of claim 2, further comprising housing means for containing the anode and cathode compartments.

7. The electrophoresis apparatus of claim 6, wherein at least a portion of the housing means is made of a material having a thermal conductivity greater than about 1 W/mK and a specific heat greater than about 100 J/kgK.

8. The electrophoresis apparatus of claim 7, wherein the material of the at least portion of the housing means is selected from the group consisting of alumina, aluminum nitride, zirconia, zirconium nitride, boron nitride, silicon nitride, silicon carbide, ceramics, fused silica, quartz, glass or any combination thereof.

9. The electrophoresis apparatus of claim 1, wherein the electrically insulating material of the at least one part of the anode or cathode compartment is selected from the group consisting of alumina, aluminum nitride, zirconia, zirconium nitride, boron nitride, silicon nitride, silicon carbide, ceramics, fused silica, quartz, glass or any combination thereof.

10. The electrophoresis apparatus of claim 1, wherein the aspect ratio of at least one of the anode compartment and the cathode compartment is less than about ½.

11. The electrophoresis apparatus of claim 10, wherein the aspect ratio of at least one of the anode compartment and the cathode compartment is less than about ⅕.

12. The electrophoresis apparatus of claim 11, wherein the aspect ratio of at least one of the anode compartment and the cathode compartment is less than about 1/10.

13. The electrophoresis apparatus of claim 12, wherein the aspect ratio of at least one of the anode compartment and the cathode compartment is less than about 1/20.

14. The electrophoresis apparatus of claim 1, wherein the ion-permeable barrier is essentially free of weekly acidic functional groups or weakly basic functional groups or anionic functional groups or cationic functional groups.

15. The electrophoresis apparatus of claim 1, wherein the ion-permeable barrier is an isoelectric barrier.

16. An electrophoresis apparatus comprising:
an anode and a cathode, the cathode spaced from the anode so as to define a distance along a longitudinal axis, the anode and cathode further defining an electric field having a direction substantially along the longitudinal axis;
an anode compartment, the anode disposed therein;
a cathode compartment, the cathode disposed therein;
at least one separation compartment positioned between the anode and cathode compartments, each of the anode compartment, cathode compartment and at least one separation compartment being configured to hold at least one electrolyte, at least one of the anode compartment, cathode compartment and at least one separation compartment being configured to hold at least a portion of a sample, and each of the anode compartment, cathode compartment and at least one separation compartment including:
means for an addition or removal of a solution;
a first compartment dimension, a second compartment dimension, and a third compartment dimension, the first compartment dimension being substantially orthogonal to the direction of the electric field, the second compartment dimension being substantially orthogonal to the direction of the electric field and the first compartment dimension, a ratio of the first compartment dimension and the second compartment dimension defining an aspect ratio of the compartment, and the third compartment dimension being substantially parallel to the direction of the electric field and substantially orthogonal to the first and second compartment dimensions; and
an ion-permeable barrier positioned between each of the anode compartment, the at least one separation compartment and the cathode compartment, the ion-permeable barrier being configured to prevent convective mixing therebetween, wherein
at least a portion of at least one of the anode compartment, the cathode compartment and the at least one separation compartment is made of an electrically insulating material having a thermal conductivity greater than about 1 W/mK and a specific heat greater than about 100 J/kgK and the aspect ratio of at least one of the anode compartment, the cathode compartment and the at least one separation compartment is less than one.

17. The electrophoresis apparatus of claim 16, further comprising sealing means disposed between the anode compartment, the cathode compartment and the at least one separation compartment.

18. The electrophoresis apparatus of claim 17, wherein the sealing means is adapted to contain the ion-permeable barrier and provide access of ions to the ion-permeable barrier.

19. The electrophoresis apparatus of claim 17, wherein the sealing means is made of a water insoluble polymer, the polymer being natural or synthetic.

20. The electrophoresis apparatus of claim 19, wherein the water insoluble polymer is selected from the group consisting of polyethylene, polypropylene, polyisobutylene, polyalkylenes, polyfluorocarbons, poly(dimethylsiloxane), poly(dialkylsiloxane), poly(alkylarylsiloxane), poly(diarylsiloxane), poly(ether ether ketones) or a combination thereof.

21. The electrophoresis apparatus of claim 16, further comprising housing means for containing the anode compartment, the cathode compartment and the at least one separation compartment.

22. The electrophoresis apparatus of claim 21, wherein at least a portion of the housing means is made of a material having a thermal conductivity greater than about 1 W/mK and a specific heat greater than about 100 J/kgK.

23. The electrophoresis apparatus of claim 22, wherein the material of the at least portion of the housing means is selected from the group consisting of alumina, aluminum nitride, zirconia, zirconium nitride, boron nitride, silicon nitride, silicon carbide, ceramics, fused silica, quartz, glass or any combination thereof.

24. The electrophoresis apparatus of claim 16, wherein the electrically insulating material of the anode compartment, the cathode compartment and the at least one separation compartment is selected from the group consisting of alumina, aluminum nitride, zirconia, zirconium nitride, boron nitride, silicon nitride, silicon carbide, ceramics, fused silica, quartz, glass or any combination thereof.

25. The electrophoresis apparatus of claim 16, wherein at least one of the ion-permeable barriers is essentially free of weekly acidic functional groups or weakly basic functional groups or anionic functional groups or cationic functional groups.

26. The electrophoresis apparatus of claim 16, wherein at least one of the ion-permeable barriers is an isoelectric barrier.

27. The electrophoresis apparatus of claim 16, wherein the first dimension of the at least one separation compartment is less than about 5 millimeters.

28. The electrophoresis apparatus of claim 27, wherein the first dimension of the at least one separation compartment is less than about 3 millimeters.

29. The electrophoresis apparatus of claim 28, wherein the first dimension of the at least one separation compartment is less than about 2 millimeters.

30. The electrophoresis apparatus of claim 29, wherein the first dimension of the at least one separation compartment is less than about 1 millimeter.

31. The electrophoresis apparatus of claim 16, wherein the at least one separation compartment includes a first separation compartment and at least a second separation compartment, the first dimension of the first separation compartment being different than the first dimension of at least one of the anode compartment, the cathode compartment and the at least one second separation compartment.

32. The electrophoresis apparatus of claim 16, wherein the aspect ratio of the at least one separation compartment is less than about ½.

33. The electrophoresis apparatus of claim 32, wherein the aspect ratio of the at least one separation compartment is less than about ⅕.

34. The electrophoresis apparatus of claim 33, wherein the aspect ratio of the at least one separation compartment is less than about 1/10.

35. The electrophoresis apparatus of claim 34, wherein the aspect ratio of the at least one separation compartment is less than about 1/20.

36. The electrophoresis apparatus of claim 16, wherein the third dimension of the at least one separation compartment is less than about ½ of the distance between the anode and cathode.

37. The electrophoresis apparatus of claim 36, wherein the third dimension of the at least one separation compartment is less than about ⅓ of the distance between the anode and cathode.

38. The electrophoresis apparatus of claim 16, wherein the aspect ratio of at least one of the anode compartment, the at least one separation compartment and the cathode compartment is less than about ½.

39. The electrophoresis apparatus of claim 38, wherein the aspect ratio of at least one of the anode compartment, the at least one separation compartment and the cathode compartment is less than about ⅕.

40. The electrophoresis apparatus of claim 39, wherein the aspect ratio of at least one of the anode compartment, the at least one separation compartment and the cathode compartment is less than about 1/10.

41. The electrophoresis apparatus of claim 40, wherein the aspect ratio of at least one of the anode compartment, the at least one separation compartment and the cathode compartment is less than about 1/20.

42. The electrophoresis apparatus of claim 16, wherein the apparatus includes at least two separation compartments.

43. The electrophoresis apparatus of claim 42, wherein the apparatus includes at least three separation compartments.

44. The electrophoresis apparatus of claim 43, wherein the apparatus includes at least five separation compartments.

45. The electrophoresis apparatus of claim 44, wherein the apparatus includes at least ten separation compartments.

46. The electrophoresis apparatus of claim 45, wherein the apparatus includes at least twenty separation compartments.

47. The electrophoresis apparatus of claim 46, wherein the apparatus includes at least fifty separation compartments.

48. The electrophoresis apparatus of claim 16, wherein the third dimension of the anode compartment, the at least one separation compartment and the cathode compartment are the same.

49. The electrophoresis apparatus of claim 16, wherein at least two members of the group comprising the anode compartment, the at least one separation compartments and the cathode compartment have different third dimensions.

50. An electrophoresis apparatus comprising:
an anode compartment, a cathode compartment and at least one separation compartment therebetween, an anode in the anode compartment, a cathode in the cathode compartment, the anode and cathode defining an electric field therebetween, the electric field defining a direction from the anode to the cathode;
each compartment being configured to hold at least an electrolyte, at least one of the compartments being configured to hold at least a portion of a sample, each compartment having a first dimension substantially orthogonal to the direction of the electric field, a second dimension substantially orthogonal to the direction of the electric field and the first dimension, and a third dimension substantially parallel to the direction of the electric field, a ratio of the first and second dimensions of each compartment defining an aspect ratio for each compartment;
an ion-permeable barrier positioned between adjacent compartments so as to restrict convective mixing between the adjacent compartments;
wherein at least a portion of at least one of the compartments is made of a material having heat transfer properties including at least one of a thermal conductivity greater than about 1 W/mK and a specific heat greater than about 100 J/kgK and wherein further at least one of the aspect ratios is less than one.

51. An electrophoresis apparatus comprising:
an anode compartment, a cathode compartment and a plurality of separation compartments therebetween, an anode in the anode compartment, a cathode in the cathode compartment, the anode and cathode defining an electrode distance therebetween, the anode and cathode defining an electric field therebetween, the electric field defining a direction from the anode to the cathode;
the anode compartment being configured to hold an acidic solution, the cathode compartment being configured to hold a basic solution, at least one of the plurality of separation compartments being configured to hold at least a portion of a sample, each compartment having a first dimension substantially orthogonal to the direction of the electric field, a second dimension substantially orthogonal to the direction of the electric field and the first dimension, and a third dimension substantially parallel to the direction of the electric field, a ratio of the first and second dimensions of each compartment defining an aspect ratio for each compartment, each compartment having means for an addition or removal of a solution;
the anode compartment connected to the plurality of separation compartments through an isoelectric ion-permeable barrier restricting convective mixing between the connected compartments;
the cathode compartment connected to the plurality of separation compartment through an isoelectric ion-permeable barrier restricting convective mixing between the connected compartments;
each of the plurality of separation compartments being connected to each adjacent separation compartment through an ion-permeable barrier restricting convective mixing between the connected separation compartments, wherein
each of the plurality of separation compartments being made of alumina having a thermal conductivity greater than about 20 W/mK and a specific heat greater than about 200 J/kgK, an aspect ratio less than one fifth, and having a third dimension less than one third of the electrode distance.

52. An electrophoresis apparatus according to claim 51, wherein the ion-permeable barrier between each adjacent separation compartment is an isoelectric barrier.

53. An electrophoresis apparatus according to claim 51, wherein at least one of the ion-permeable barriers between the adjacent separation compartments is an isoelectric barrier.

54. An electrophoresis apparatus according to claim 51, wherein the ion-permeable barrier between each adjacent separation compartment is essentially free of weakly acidic, weakly basic, anionic and cationic functional groups.

55. A method of altering a composition of a sample by electrophoresis, the method comprising
providing an electrophoretic apparatus according to claim 1;
selecting an ion-permeable barrier for use between the anode and cathode compartments;
providing an electrolyte to the anode compartment;
providing an electrolyte to the cathode compartment;
providing the sample to at least one of the compartments;
creating an electrophoretic direct current between the anode and the cathode by applying an electric potential between the anode and the cathode, and
causing a transfer of at least one part of at least one component of the sample across the ion-permeable barrier.

56. A method of altering a composition of a sample by electrophoresis, the method comprising
providing an electrophoretic apparatus according to claim 16;
selecting an ion-permeable barrier for use between the adjacent compartments;
providing the sample to at least one of the compartments;
providing at least one electrolyte to any of the compartments free of the sample;
creating an electrophoretic direct current between the anode and the cathode by applying an electric potential between the anode and the cathode, and
causing a transfer of at least one part of at least one component of the sample across an ion-permeable barrier.

57. An electrophoresis apparatus substantially as shown and described as in FIGS. 1A and 1B.

58. An electrophoresis apparatus substantially as shown and described as in FIGS. 2A and 2B.

59. An electrophoresis apparatus substantially as shown and described as in FIGS. 2A and 2B.
